(19) United States
(12) Patent Application Publication
(10) Pub. No.: US 2013/0297053 A1
(43) Pub. Date: Nov. 7, 2013

(54) AUDIO SCENE PROCESSING APPARATUS

(71) Applicant: Juha Ojanperä, Nokia (FI)

(72) Inventor: Juha Ojanperä, Nokia (FI)

(73) Assignee: NOKIA CORPORATION, Espoo (FI)

(21) Appl. No.: 13/979,791

(22) PCT Filed: Jan. 17, 2011
(86) PCT No.: PCT/IB11/50197

§ 371 Date: Jul. 15, 2013

(51) Int. Cl. G06F 17/30

(52) U.S. Cl. CPC G06F 17/3074
USPC 700/94

(57) ABSTRACT

An apparatus comprising: an audio source selector configured to select a set of audio signals from received audio signals; an audio source classifier configured to classify each of the set of audio signals dependent on at least one audio characteristic; and a classification selector configured to select from the set of audio signals at least one audio signal dependent on the audio characteristic.

### FIELD OF THE APPLICATION

The present application relates to apparatus for the processing of audio and additionally video signals. The invention further relates to, but is not limited to, apparatus for processing audio and additionally video signals from mobile devices.

### BACKGROUND OF THE APPLICATION

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

Where there is multiple user generated content for the same event it can be possible to generate an improved content rendering of the event by combining various different recordings from different users or improve upon user generated content from a single source, for example reducing background noise by mixing different users content to attempt to overcome local interference, or uploading errors.

However the selection of suitable audio signals can be a problem in multiple user generated or recorded systems where the recording devices are in close proximity and the same audio scene is recorded multiple times.

As the typical accuracy of global positioning satellite (GPS) estimation of the position of the multiple user generated systems is between 1 to 15 metres the localisation of an audio source can be difficult to perform in order to be able to distinguish between each recording source using the GPS information. Furthermore GPS or other beacon based location estimation systems (such as cellular radio based location estimation) has a significantly degraded performance when used in indoor environments. Furthermore in such multiple user systems it is typically the relative distance between a recording source and selected listening point to determine the selection criteria and not the absolute location estimate which can lead to further errors.

This has led to the typical audio or sound source selector to be complex and inflexible. For example some selection processes can rely on selecting audio sources with the loudest volume rather than the audio recording system with the best quality audio captured and therefore produce poor quality audio signals for the end user.

### SUMMARY OF THE APPLICATION

Aspects of this application thus provide an audio source classification process whereby multiple devices can be present and recording audio signals and a server can classify and select from these audio sources suitable signals from the uploaded data.

There is provided according to the application an apparatus comprising at least one processor and at least one memory including computer code, the at least one memory and the computer code configured to with the at least one processor cause the apparatus to at least perform: selecting a set of audio signals from received audio signals; classifying each of the set of audio signals dependent on at least one audio characteristic; and selecting from the set of audio signals at least one audio signal dependent on the audio characteristic.

Selecting a set of audio signals from received audio signals may cause the apparatus to perform: determining for each received audio signal a location estimation; and selecting the set of audio signals from the received audio signals dependent on the location estimation associated with the received audio signal.

Selecting the set of audio signals from the received audio signals dependent on the location estimation associated with the received audio signal may cause the apparatus to perform: selecting the set of audio signals from the received audio signals dependent on the location estimation being within a determined audio scene area.

Classifying each of the set of audio signals may cause the apparatus to perform: determining at least one audio characteristic value associated with each of the set of the audio signals compared to an associated reference signal; and classifying each of the set of audio signals dependent on the at least one audio characteristic value associated with each audio signal.

Classifying each of the set of audio signals dependent on the at least one audio characteristic value associated with each audio signal may cause the apparatus to perform mapping the at least one audio characteristic value associated with each audio signal to one of a defined number of audio characteristic levels.

Mapping the at least one audio characteristic value associated with each audio signal to one of the defined number of audio characteristic levels may cause the apparatus to perform: mapping a first audio characteristic value associated with each audio signal to one of a first defined number of levels associated with the first classification; mapping a second audio characteristic value associated with each audio signal to one of a second number of levels associated with the second classification; and combining the first classification mapping level and the second classification mapping level.

Combining the first characteristic value mapping level and the second characteristic value mapping level may cause the apparatus to perform averaging the first characteristic value mapping level and the second characteristic value mapping level.

Determining at least one audio characteristic value associated with each of the set of the audio signals compared to a reference signal may cause the apparatus to perform at least one of: determining a spectral distance associated with each of the set of audio signals compared to the associated reference signal; and determining a frequency response distance with each of the set of audio signals compared to the associated reference signal.

Determining a spectral distance associated with each of the set of audio signals compared to the associated reference signal may cause the apparatus to perform determining the spectral distance, Xdist, for each audio signal, xₘ, according to the following equations:

$${X}_{{diff}_{m}} [ k , r ] = {\sum }_{tl = I \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = \vert \vert {X}_{{diff}_{m}} [ binIdx , r ] {\vert \vert}^{2} , sbOffset [ sb ] \leq binIdx < sbOffset [ sb + 1 ] ,$$

where sbOffset describes frequency band boundaries,

$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k , tl ]}{N} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

Determining a frequency response distance with each of the set of audio signals compared to the associated reference signal may cause the apparatus to perform determining the difference signal, Xdist, for each audio signal, xₘ, according to the following equations:

$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$

where sbOffset describes frequency band boundaries,

$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

Classifying each of the set of audio signals dependent on the at least one classification value associated with each audio signal may cause the apparatus to perform: further classifying the each of the set of audio signals dependent on an orientation of the audio signal.

Selecting from the set of audio signals at least one audio signal dependent on the audio characteristic may cause the apparatus to perform selecting from the set of audio signals at least one audio signal dependent on the characteristic value mapping level.

The apparatus may further be caused to perform processing the selected at least one audio signal from the set of audio signals.

The apparatus may further be caused to output the selected at least one audio signal.

The apparatus may further be caused to receive at least one audio scene parameter, wherein the audio scene parameter may comprise at least one of: an audio scene location; an audio scene area; an audio scene radius; an audio scene direction; and an audio scene perceptual relevance.

Selecting a set of audio signals from received audio signals may cause the apparatus to select from received audio signals which are within the audio scene area.

According to a second aspect of the application there is provided an apparatus comprising at least one processor and at least one memory including computer code, the at least one memory and the computer code configured to with the at least one processor cause the apparatus to at least perform: defining at least one first audio scene parameter; outputting the first audio scene to a further apparatus; receiving at least one audio signal from the further apparatus dependent on the at least one first audio scene parameter; and presenting the at least one audio signal.

The further apparatus may comprise the apparatus as described herein.

The at least one first audio scene parameter may comprise at least one of: an audio scene location; an audio scene radius; an audio scene direction; and an audio scene perceptual relevance.

The apparatus may further be caused to render the received at least one audio signal from the further apparatus into a format suitable for presentation by the apparatus.

According to a third aspect of the application there is provided a method comprising: selecting a set of audio signals from received audio signals; classifying each of the set of audio signals dependent on at least one audio characteristic; and selecting from the set of audio signals at least one audio signal dependent on the audio characteristic.

Selecting a set of audio signals from received audio signals comprises: determining for each received audio signal a location estimation; and selecting the set of audio signals from the received audio signals dependent on the location estimation associated with the received audio signal.

Selecting the set of audio signals from the received audio signals dependent on the location estimation associated with the received audio signal may comprise: selecting the set of audio signals from the received audio signals dependent on the location estimation being within a determined audio scene area.

Classifying each of the set of audio signals may comprise: determining at least one audio characteristic value associated with each of the set of the audio signals compared to an associated reference signal; and classifying each of the set of audio signals dependent on the at least one audio characteristic value associated with each audio signal.

Classifying each of the set of audio signals dependent on the at least one audio characteristic value associated with each audio signal may comprise mapping the at least one audio characteristic value associated with each audio signal to one of a defined number of audio characteristic levels.

Mapping the at least one audio characteristic value associated with each audio signal to one of the defined number of audio characteristic levels may comprises: mapping a first audio characteristic value associated with each audio signal to one of a first defined number of levels associated with the first classification; mapping a second audio characteristic value associated with each audio signal to one of a second number of levels associated with the second classification; and combining the first classification mapping level and the second classification mapping level.

Combining the first characteristic value mapping level and the second characteristic value mapping level may comprise averaging the first characteristic value mapping level and the second characteristic value mapping level.

Determining at least one audio characteristic value associated with each of the set of the audio signals compared to a reference signal may comprise at least one of: determining a spectral distance associated with each of the set of audio signals compared to the associated reference signal; and determining a frequency response distance with each of the set of audio signals compared to the associated reference signal.

Determining a spectral distance associated with each of the set of audio signals compared to the associated reference signal may comprise determining the spectral distance, Xdist, for each audio signal, xₘ, according to the following equations:

$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = {‖ {X}_{{diff}_{m}} [ binIdx , r ] ‖}^{2} , \\ sbOffset [ sb ] \leq binIdx < sbOffset [ sb + 1 ] ,$$

where sbOffset describes frequency band boundaries,

$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k , tl ]}{N} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

Determining a frequency response distance with each of the set of audio signals compared to the associated reference signal may comprise determining the difference signal, Xdist, for each audio signal, xₘ, according to the following equations:

$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$

where sbOffset describes frequency band boundaries,

$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

Classifying each of the set of audio signals dependent on the at least one classification value associated with each audio signal may comprise: further classifying the each of the set of audio signals dependent on an orientation of the audio signal.

Selecting from the set of audio signals at least one audio signal dependent on the audio characteristic may comprise selecting from the set of audio signals at least one audio signal dependent on the characteristic value mapping level.

The method may further comprise processing the selected at least one audio signal from the set of audio signals.

The method may further comprise outputting the selected at least one audio signal.

The method may further comprise receiving at least one audio scene parameter, wherein the audio scene parameter may comprise at least one of: an audio scene location; an audio scene area; an audio scene radius; an audio scene direction; and an audio scene perceptual relevance.

Selecting a set of audio signals from received audio signals may comprise selecting from received audio signals which are within the audio scene area.

According to a fourth aspect of the application there is provided a method comprising: defining at least one first audio scene parameter; outputting the first audio scene to an apparatus; receiving at least one audio signal from the apparatus dependent on the at least one first audio scene parameter; and presenting the at least one audio signal.

The at least one first audio scene parameter may comprise at least one of: an audio scene location; an audio scene radius; an audio scene direction; and an audio scene perceptual relevance.

The method may further comprise rendering the received at least one audio signal from the apparatus into a format suitable for presentation.

There is provided according to a fifth aspect an apparatus comprising: an audio source selector configured to select a set of audio signals from received audio signals; an audio source classifier configured to classify each of the set of audio signals dependent on at least one audio characteristic; and a classification selector configured to select from the set of audio signals at least one audio signal dependent on the audio characteristic.

The audio source selector may comprise: a source locator configured to determine for each received audio signal a location estimation; and a source selector configured to select the set of audio signals from the received audio signals dependent on the location estimation associated with the received audio signal.

The source selector may be configured to select the set of audio signals from the received audio signals dependent on the location estimation being within a determined audio scene area.

The audio source classifier may comprise: an audio characteristic value determiner configured to determine at least one audio characteristic value associated with each of the set of the audio signals compared to an associated reference signal; and a characteristic value classifier configured to classify each of the set of audio signals dependent on the at least one audio characteristic value associated with each audio signal.

The characteristic value classifier may comprise a mapper configured to map the at least one audio characteristic value associated with each audio signal to one of a defined number of audio characteristic levels.

The mapper may comprise: a first characteristic mapper configured to map a first audio characteristic value associated with each audio signal to one of a first defined number of levels associated with the first classification; a second characteristic mapper configured to map a second audio characteristic value associated with each audio signal to one of a second number of levels associated with the second classification; and a level combiner configured to combine the first classification mapping level and the second classification mapping level.

The level combiner may be configured to average the first characteristic value mapping level and the second characteristic value mapping level.

The audio characteristic value determiner may comprise: a spectral distance determiner configured to determine a spectral distance associated with each of the set of audio signals compared to the associated reference signal; and a frequency response determiner configured to determine a frequency response distance with each of the set of audio signals compared to the associated reference signal.

The spectral distance determiner may be configured to determine the spectral distance, Xdist, for each audio signal, xₘ, according to the following equations:

$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = {‖ {X}_{{diff}_{m}} [ binIdx , r ] ‖}^{2} , \\ sbOffset [ sb ] \leq binIdx < sbOffset [ sb + 1 ] ,$$

where sbOffset describes frequency band boundaries,

$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k , tl ]}{N} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

The frequency response determiner may be configured to determine the difference signal, Xdist, for each audio signal, xₘ, according to the following equations:

$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$

where sbOffset describes frequency band boundaries,

$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

The audio source classifier may further comprise an orientation classifier configured to further classify the each of the set of audio signals dependent on an orientation of the audio signal.

The classification selector may be configured to select from the set of audio signals at least one audio signal dependent on the characteristic value mapping level.

The apparatus may further comprise a processor configured to process the selected at least one audio signal from the set of audio signals.

The apparatus may further comprise a transmitter configured to output the selected at least one audio signal.

The apparatus may further comprise a receiver configured to receive at least one audio scene parameter, wherein the audio scene parameter comprises at least one of: an audio scene location; an audio scene area; an audio scene radius; an audio scene direction; and an audio scene perceptual relevance.

The audio source selector may be configured to select from received audio signals which are within the audio scene area.

According to a sixth aspect of the application there is provided an apparatus comprising: an audio scene determiner configured to define at least one first audio scene parameter; a transmitter configured to output the first audio scene parameter to a further apparatus; a receiver configured to receive at least one audio signal from the further apparatus dependent on the at least one first audio scene parameter; and an audio signal presenter configured to present the at least one audio signal.

The further apparatus may comprise the apparatus as described herein.

The at least one first audio scene parameter may comprise at least one of: an audio scene location; an audio scene radius; an audio scene direction; and an audio scene perceptual relevance.

The apparatus may further comprise a renderer configured to render the received at least one audio signal from the further apparatus into a format suitable for presentation by the apparatus.

There is provided according to a seventh aspect an apparatus comprising: means for selecting a set of audio signals from received audio signals; means for classifying each of the set of audio signals dependent on at least one audio characteristic; and means for selecting from the set of audio signals at least one audio signal dependent on the audio characteristic.

The means for selecting a set of audio signals from received audio signals may comprise: means for determining for each received audio signal a location estimation; and means for selecting the set of audio signals from the received audio signals dependent on the location estimation associated with the received audio signal.

The means for selecting the set of audio signals from the received audio signals dependent on the location estimation associated with the received audio signal may comprise: means for selecting the set of audio signals from the received audio signals dependent on the location estimation being within a determined audio scene area.

The means for classifying each of the set of audio signals may comprise: means for determining at least one audio characteristic value associated with each of the set of the audio signals compared to an associated reference signal; and means for classifying each of the set of audio signals dependent on the at least one audio characteristic value associated with each audio signal.

The means for classifying each of the set of audio signals dependent on the at least one audio characteristic value associated with each audio signal may comprise means for mapping the at least one audio characteristic value associated with each audio signal to one of a defined number of audio characteristic levels.

The means for mapping the at least one audio characteristic value associated with each audio signal to one of the defined number of audio characteristic levels may comprise: means for mapping a first audio characteristic value associated with each audio signal to one of a first defined number of levels associated with the first classification; means for mapping a second audio characteristic value associated with each audio signal to one of a second number of levels associated with the second classification; and means for combining the first classification mapping level and the second classification mapping level.

The means for combining the first characteristic value mapping level and the second characteristic value mapping level may comprise means for averaging the first characteristic value mapping level and the second characteristic value mapping level.

The means for determining at least one audio characteristic value associated with each of the set of the audio signals compared to a reference signal may comprise at least one of: means for determining a spectral distance associated with each of the set of audio signals compared to the associated reference signal; and means for determining a frequency response distance with each of the set of audio signals compared to the associated reference signal.

The means for determining a spectral distance associated with each of the set of audio signals compared to the associated reference signal may comprise means for determining the spectral distance, Xdist, for each audio signal, xₘ, according to the following equations:

$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = {‖ {X}_{{diff}_{m}} [ binIdx , r ] ‖}^{2} , \\ sbOffset [ sb ] \leq binIdx < sbOffset [ sb + 1 ] ,$$

where sbOffset describes frequency band boundaries,

$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k , tl ]}{N} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

The means for determining a frequency response distance with each of the set of audio signals compared to the associated reference signal may comprise means for determining the difference signal, Xdist, for each audio signal, xₘ, according to the following equations:

$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$

where sbOffset describes frequency band boundaries,

$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , l \cdot L \leq tl < ( l + 1 ) \cdot L ,$$

where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

The means for classifying each of the set of audio signals dependent on the at least one classification value associated with each audio signal may comprise: means for classifying the each of the set of audio signals dependent on an orientation of the audio signal.

The means for selecting from the set of audio signals at least one audio signal dependent on the audio characteristic may comprise means for selecting from the set of audio signals at least one audio signal dependent on the characteristic value mapping level.

The apparatus may further comprise means for processing the selected at least one audio signal from the set of audio signals.

The apparatus may further comprise means for outputting the selected at least one audio signal.

The apparatus may further comprise means for receiving at least one audio scene parameter, wherein the audio scene parameter comprises at least one of: an audio scene location; an audio scene area; an audio scene radius; an audio scene direction; and an audio scene perceptual relevance.

The means for selecting a set of audio signals from received audio signals may further comprise means for selecting from received audio signals which are within the audio scene area.

According to a eighth aspect of the application there is provided an apparatus comprising: means for defining at least one first audio scene parameter; means for outputting the first audio scene to a further apparatus; means for receiving at least one audio signal from the further apparatus dependent on the at least one first audio scene parameter; and means for presenting the at least one audio signal.

The further apparatus may comprise the apparatus as described herein.

The at least one first audio scene parameter may comprise at least one of: an audio scene location; an audio scene radius; an audio scene direction; and an audio scene perceptual relevance.

The apparatus may further comprise means for rendering the received at least one audio signal from the further apparatus into a format suitable for presentation by the apparatus.

An electronic device may comprise apparatus as described herein.

A chipset may comprise apparatus as described herein.

Embodiments of the present invention aim to address the above problems.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an audio scene system according to some embodiments of the application;

FIG. 4 shows a flow diagram of the operation of the audio scene system according to some embodiments;

FIG. 5 shows schematically an audio scene processor as shown in FIG. 3 according to some embodiments of the application;

FIG. 6 shows a flow diagram of the operation of the audio scene processor to some embodiments;

FIG. 7 shows schematically the audio source classifier as shown in FIG. 5 in further detail;

FIG. 8 shows a flow diagram of the operation of the audio source classifier according to some embodiments; and

FIGS. 9 to 12 show schematically the operation of the audio scene system according to some embodiments.

### EMBODIMENTS OF THE APPLICATION

The following describes in further detail suitable apparatus and possible mechanisms for the provision of effective audio scene processing. In the following examples audio signals and audio capture uploading and downloading is described. However it would be appreciated that in some embodiments the audio signal/audio capture, uploading and downloading is part of an overall audio-video system.

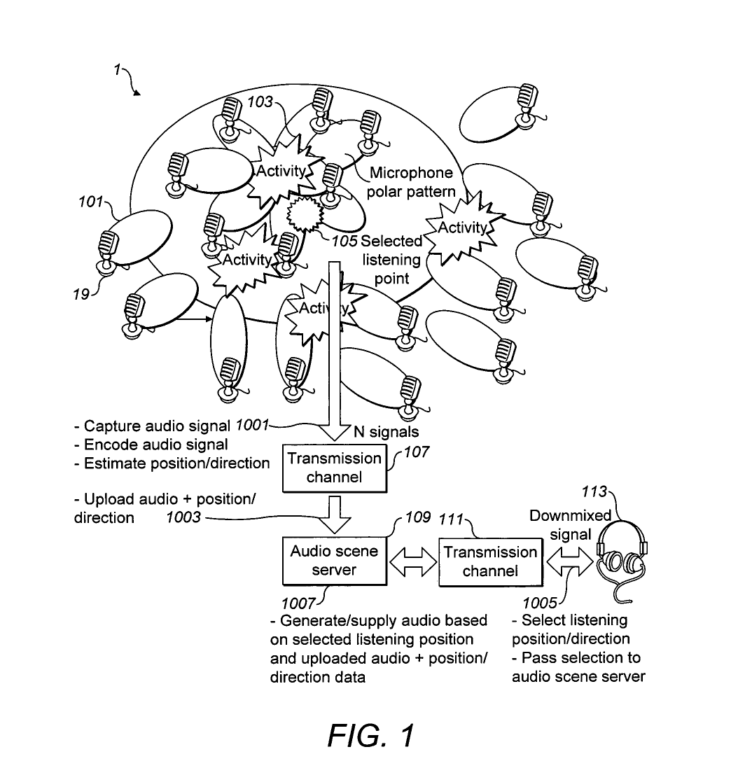

With respect to FIG. 1 an overview of a suitable system within which embodiments of the application can be located is shown. The audio space 1 can have located within it at least one recording or capturing devices or apparatus 19 which are shown arbitrarily positioned within the audio space to record suitable audio scenes. The apparatus shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a news worthy event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal.

The capturing and encoding of the audio signal and the estimation of the position/direction of the apparatus is shown in FIG. 1 by step 1001.

The uploading of the audio and position/direction estimate to the audio scene server is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113. In some embodiments as described herein the audio scene server 109 can be configured to select captured audio signals from at least one of the apparatus within the audio scene defined with respect to the desired or selected listening point, and to transmit these to the listening device 113 via the further transmission channel 111.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal. The audio scene server 109 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 109 can provide in some embodiments a selected set of downmixed signals which correspond to listening points neighbouring the desired location/direction and the listening device 113 selects the audio signal desired.

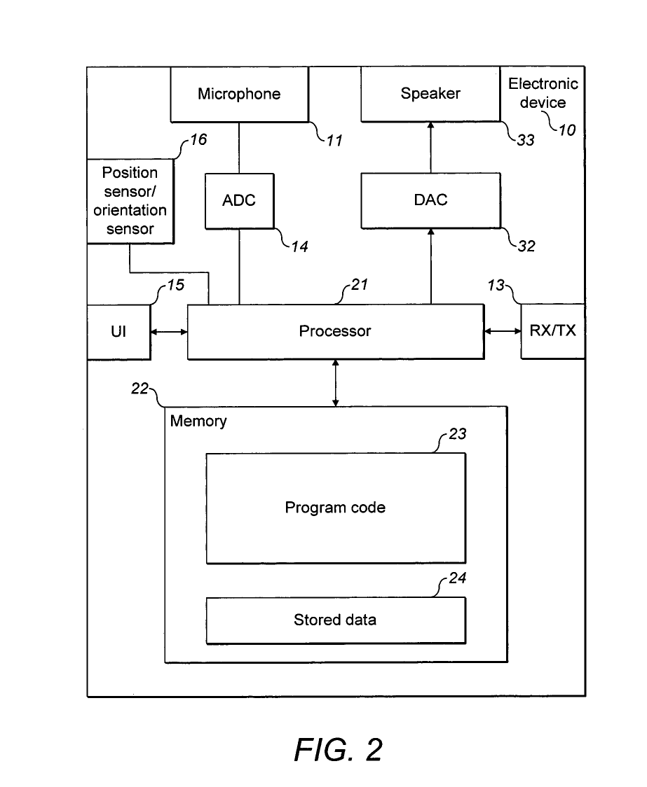

In this regard reference is first made to FIG. 2 which shows a schematic block diagram of an exemplary apparatus or electronic device 10, which may be used to record (or operate as a recording device 19) or listen (or operate as a listening device 113) to the audio signals (and similarly to record or view the audio-visual images and data). Furthermore in some embodiments the apparatus or electronic device 10 can function as the audio scene server 109.

The electronic device 10 may for example be a mobile terminal or user equipment of a wireless communication system when functioning as the recording device or listening device 113. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio encoding code routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19, or audio scene server 109) or further transmission channel 111 (where the device is functioning as the listening device 113 or audio scene server 109). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

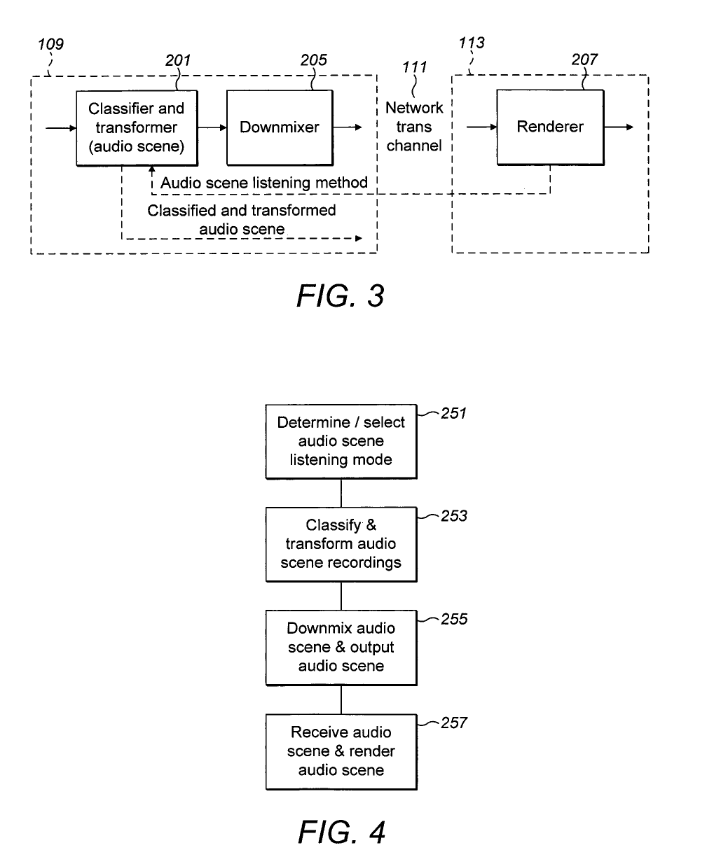

With respect to FIG. 3 an overview of the application according to some embodiments is shown with respect to the audio server 109 and listening device 113. Furthermore with respect to FIG. 4 the operational overview of some embodiments is described. As described herein the audio server 109 is configured to receive from the various recording devices 19 (or audio capture sources) uploaded audio signals. In some embodiments the audio scene server 109 can comprise a classifier and transformer 201. The classifier and transformer 201 is configured to, based on parameters received from the listening device 113 (such as the desired location and orientation, the desired ‘radius’ of the audio scene, and the mode of the listening device), classify and transform the audio sources within the determined audio scene.

The operation of determining or selecting the audio scene listening mode is shown in FIG. 4 by step 251.

Furthermore the operation of classifying and transforming the audio scene recordings is shown in FIG. 4 by step 253.

The classified and transformed audio sources can then be passed to the downmixer. The downmixer 205 in some embodiment is configured to using the selected audio sources generate a signal suitable for rendering at the listening device and for transmitting on the transmission channel 111 to the listening device 113. For example in some embodiments the downmixer 205 can be configured to receive multiple audio source signals from at least one selected audio source and generate a multi-channel or single channel audio signal simulating the effect of being located at the desired listening position and in a format suitable for the listening device. For example where the listening device is a stereo head set the downmixer 205 can be configured to generate a stereo signal.

The operation of downmixing and outputting the audio scene signal is shown in FIG. 4 by step 255.

Furthermore in some embodiments the listening device 113 can comprise a renderer 207. The renderer 207 can be configured to receive the downmixed output signal via the transmission channel 111 and generate a rendered signal suitable for the listening device end user. For example in some embodiments the renderer 207 can be configured to decode the encoded audio signal output by the downmixer 205 in a format suitable for presentation to a stereo headset or headphones or speaker.

The operation of receiving the audio scene and rendering the audio scene is shown in FIG. 4 by step 257.

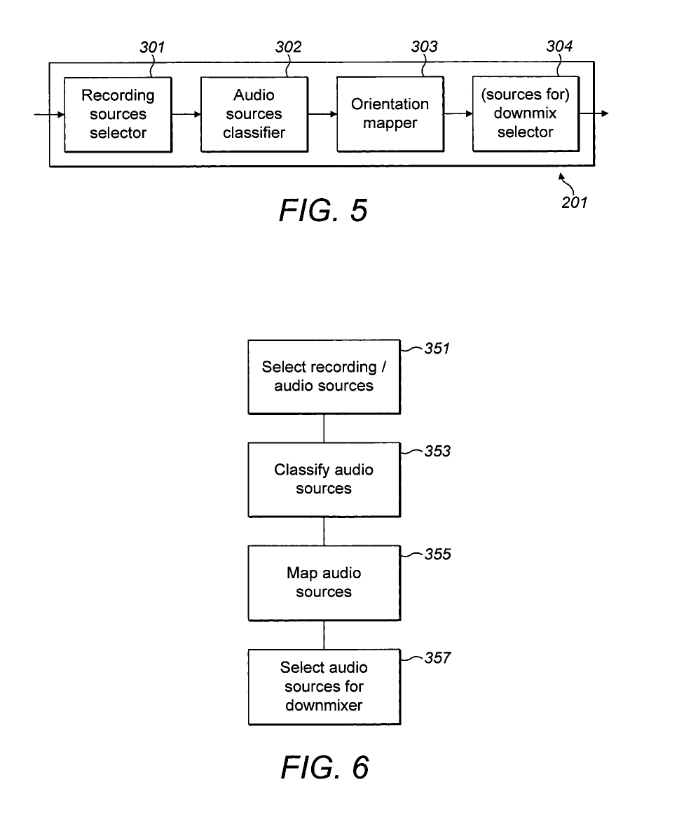

With respect to FIG. 5 the classifier and transformer 201 is shown in further detail. Furthermore with respect to FIG. 6 the operation of the classifier and transformer 201 according to some embodiments is shown in further detail.

In some embodiments the classifier and transformer 201 can comprise a recording source selector 301. The recording source selector 301 is configured to receive the audio signals received from the audio sources or recording devices and determine a first filtering to determine which recording sources can be determined as being included in the ‘audio scene’. In other words the apparatus comprises in some embodiments means for selecting a set of audio signals from received audio signals. In some embodiments the recording source selector 301 can select the audio sources to be included in the “audio scene” using the location estimates associated with the recording sources or devices and the desired listening location. In such embodiments there can therefore comprise means for selecting the set of audio signals from the received audio signals dependent on the location estimation being within a determined audio scene area. In some embodiments the uploaded audio signals can comprise a data signal associated with each audio signal, the data signal comprising the location estimate of the audio signal position and orientation which can be used to perform a first ‘location’ based selection of the audio sources to be further processed. In other words there can comprise in some embodiments means for determining for each received audio signal a location estimation; and means for selecting the set of audio signals from the received audio signals dependent on the location estimation associated with the received audio signal.

In some embodiments the recording source selector 301 can be configured to receive information from or via the listening device determining the ‘range’ or radius of the audio scene as well as the desired location of the listening position. This information can, in such embodiments, be used by the recording source selector 301 to determine or define the parameters used to determine ‘suitable’ recording or capture or audio sources. In some embodiments the selection of suitable audio sources can be fixed at a determined maximum value so to determine a processing capacity required in the further processing operations described herein. In some embodiments the following pseudo code can be used to implement an audio source selector operation.
1. Let the listening position be at (x,y) position
2. Set m=0 and r=2 meters
3. Find the audio sources that are estimated to be within r meter distance from the listening point and that have not yet been included in the initial audio scene. Increase the value of variable (m) that indicates the amount of attached audio sources to the listening point so far.
4. If m<M and r<R
   Increase r=r+2 meters
   Goto step 3
   Else
   Exit

In such embodiments the value of M would determine the maximum number of audio sources that are allowed to be used or selected for further processing and the value of R determines the maximum range from the desired listening point to be used for selection of ‘suitable’ audio sources.

In some embodiments the recording sources selector 301 is configured to select audio sources based on only the estimated distance of a recording source from the desired listening point. In other words in the above pseudo code step 4 only the value of r is considered and the number of audio sources currently included in the audio scene not considered.

Furthermore in some embodiments the location information can be unavailable. This can occur for example where the audio source or listening device is indoors. In such embodiments the initial audio scene can be generated or determined using a “last known” positional estimation for the various audio (or recording) sources. In such embodiments the selector 301 can associate a location estimate generated periodically, for example every T minutes with each audio source, to maintain that an estimated position or location is always ‘known’ for each audio source.

In some embodiments the location estimation information can be replaced or supplemented using additional metadata information provided by the user or audio source or capture device when uploading or streaming the content to the audio server. For example in some embodiments the capture device 19 can prompt the user to add a text field containing the current position of the device while recording or capturing audio signals.

Furthermore in some embodiments secondary or supplementary location estimation methods can be implemented by the capture device or audio source in case the primary location estimator, for example GPS, is not able to provide an estimate of the location at sufficient accuracy or reliability levels. Thus for example in some embodiments the location estimation process can be carried out using any known or suitable beacon location estimation techniques, for example using cellular broadcast tower information.

The recording source selector 301 can generate information regarding the selected audio or recorded sources which is passed in some embodiments to an audio source classifier 302.

The operation of selecting the recording or audio sources is shown in FIG. 6 by step 351.

In some embodiments the classifier and transformer 201 can comprise an audio source classifier 302. The audio source classifier 302 is configured to classify the selected recording sources according to a determined classification process and output the audio source classifications for further processing. In such embodiments there can be means for classifying each of the set of audio signals dependent on at least one audio characteristic. Furthermore as shown herein the means for classifying can comprise means for determining at least one audio characteristic value associated with each of the set of the audio signals compared to an associated reference signal and means for classifying each of the set of audio signals dependent on the at least one audio characteristic value associated with each audio signal.

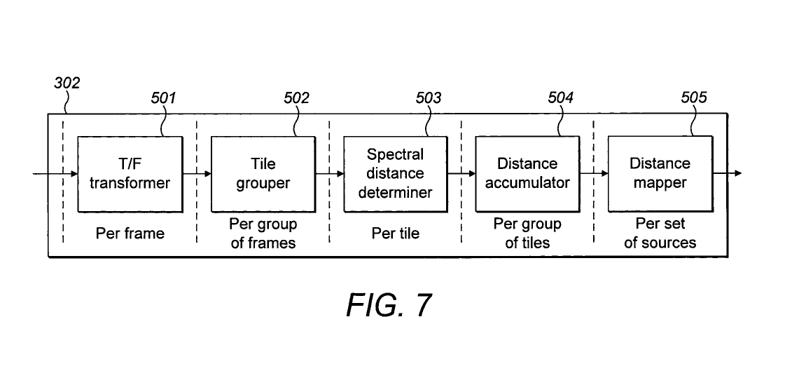

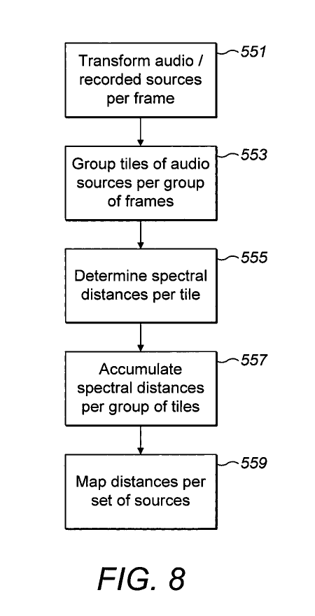

With respect to FIG. 7 an example of an audio source classifier 302 according to some embodiments of the application is shown in further detail. Furthermore with respect to FIG. 8 the operation of an audio source classifier 302 according to some embodiments is shown.

In some embodiments the audio source classifier 302 can comprise a transformer 501. The transformer 501 is configured to, on a frame by frame basis, transform the input signals for each of the selected sources from the time to the frequency domain. The transformer 501 can furthermore in some embodiments group the audio signal time domain samples into frames. For example in some embodiments the transformer 501 can generate frames 20 ms long of audio signal sample data. In some embodiments the frames can be overlapping to maintain continuity and produce a less variable output, for example in some embodiments the transformer 501 can overlap the successive generated frames of audio signals by 10 ms. However in some embodiments the transformer can generate or process frames with different sizes and with overlaps greater than or less than the values described herein.

The transformer performing a time to frequency domain operation can be represented by the following equation:

Xₘ[k,l]=TF(x_{m,l,T}),

where small m is the signal index, k is the frequency bin index, l is the time frame index, T is the hop size between successive segments, and TF is the time to frequency operator. In some embodiments the time-to-frequency operator can be a discrete Fourier transform (DFT) such as represented by the following equation:

$$T F ( {x}_{m , l , T} ) = {\sum }_{n = 0}^{NN - 1} ( w ( n ) \cdot {x}_{m} ( n + l \cdot T ) \cdot {e}^{- j \cdot {w}_{k} \cdot n} ) , \\ where$$

$${w}_{k} = \frac{2 \cdot π \cdot k}{NN} ,$$

w(n) is a NN-point analysis window, such as sinusoidal, Hanning, Hamming, Welch, Bartlett, Kaiser or Kaiser-Bessel Derived (KBD) window. In DFT, the hop size can be set to T=NN/2.

In some embodiments the transformer 501 can generate a frequency domain representation using any suitable time to frequency transformer such as discrete cosine transformer (DCT), modified discrete cosine transformer (MDCT)/modified discrete sine transformer (MDST), quadrature mirror filter (QMF), complex valued QMF.

The transformer 501 can in some embodiments output the transformed frequency domain coefficients to a tile grouper 502.

The operation of transforming the audio such recorded sources per frame is shown in FIG. 8 by step 551.

In some embodiments the audio source classifier 302 comprises a tile grouper 502. The tile grouper 502 is configured at to receive the transformed frame frequency coefficients and group a number of successive frames of audio frequency coefficients as tiles describing the time-frequency dimensions of the signal. For example in some embodiments the tile grouper 502 can be configured to form a ‘tile’ using the following equation:

Xₜᵢₗₑ_{ₘ}[k,r]=Xₘ[k,tl],l·L≦tl<(l+1)·L,

where r=1, 2, 3, . . . for every tl=L, 2L, 3L, In some embodiments a tile can be defined as having a time dimension of 250 ms and with a 20 ms frame size the number L can be determined as being 250/20=8.

The tile grouper 502 can in some embodiments be configured to output the tiles to a spectral distance determiner 503.

The operation of grouping tiles of audio sources per group of frames is shown in FIG. 8 by step 553.

In some embodiments the audio source classifier 302 comprises a spectral distance determiner 503. The spectral distance determiner 503 is configured to determine the spectral distance of the audio signals being processed. In other words the distance of an audio signal with respect to the remaining signals in the audio scene. This distance is in such embodiments not an absolute value but rather an indication of the relative position of the signal with respect to the remaining or other signals. In other words signals which appear to record the same audio scene are likely to have recorded audio or sound which is similar to each other as compared to recordings made from a greater distance in the same audio scene. The determination of the spectral distance value attempts to determine this “relativeness”. In some embodiments the spectral distance determiner 503 can be configured to carry out the operation of determining the spectral distance according to a three step process.

The spectral distance determiner 503 in some embodiments can first calculate or determine a reference signal for the tile segment. In some embodiments the spectral distance determiner 503 can determine the reference signal according to the following expression:

$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k , tl ]}{N} ,$$

where N is the number of signals present in the audio scene. The reference signal is in such embodiments the average signal in the audio scene. Other embodiments for the reference signal may determine a reference signal comprising an average amplitude signal value (and therefore ignore phase differences in the signal).

Furthermore the spectral distance determiner 503 can in some embodiments determine a difference signal on a frequency band basis. In other words the spectral distance determiner 503 having determined a reference signal for the tile can carry out the following mathematical expression to determine a difference signal:

$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = ‖ {X}_{{diff}_{m}} [ binIdx , r ] {‖}^{2} , \\ sbOffset [ sb ] \leq binIdx < sbOffset [ sb + 1 ] ,$$

where sbOffset describes the frequency band boundaries.

In some embodiments, as the human auditory system operates on a pseudo logarithmic scale, the spectral distance determiner 503 can use non-uniform frequency bands as they more closely reflect the auditory sensitivity of the user. In some embodiments of the application, the non-uniform bands follow the boundaries of the equivalent rectangular bandwidth (ERB) bands.

In some embodiments the calculation of the difference is repeated for all of the sub-bands from 0 to M where M is the number of frequency bands defined for the frame. In some embodiments the value of M may cover the entire frequency spectrum of the audio signals. In some other embodiments the number of frequency bands defined by M covers only a portion of the entire frequency spectrum. For example the M determined bands in some embodiments cover only the low frequencies as the low frequencies typically carry the most relevant information concerning the audio scene.

In such embodiments the determined difference signal Xdist describes how the energy of the signal evolves as a function of the frequency bands within the tile with respect to the reference signal. In other words the difference signal defines the signal which describes the entire audio scene. In such embodiments low values of the difference signal would be considered to be indicative that the signal is close to or highly representative of the overall audio scene whereas high values indicate that the particular signal represents details of the audio scene that are different from the overall audio scene characteristics.

Thirdly in some embodiments the spectral distance determiner 503 can determine a spectral distance value for the whole tile xDist from the determined difference signals Xdist. For example in some embodiments the spectral distance determiner 503 can determine the tile spectral distance according to the following expression:

$${xDist}_{m} [ r ] = \frac{{\sum }_{sb = 0}^{M - 1} ( \frac{{Xdist}_{m} [ sb , r ]}{{\sum }_{m = 0}^{N - 1} {Xdist}_{m} [ sb , r ]} )}{M}$$

In some embodiments the values of xDist can be normalised before accumulating the final result to ensure that the per tile value for different signals share the same level domain.

In such embodiments the spectral distance determiner 503 can be configured to pass the spectral distance values per tile to the distance accumulator 504.

The operation of determining the spectral distance per tile is shown in FIG. 8 by step 555.

In some embodiments the audio source classifier 302 can comprise a distance accumulator 504. The distance accumulator 504 is configured to in some embodiments accumulate the distance values xDist in order to smooth out any short term fluctuations which are determined in the distance values. In some embodiments the group of tiles can be accumulated or summed together such that the final distance value is generated from these groups of tiles. In some embodiments the distance accumulator 504 can perform these operations as summarised by the following equation:

$${dVal}_{m} [ s ] = {\sum }_{u = r \cdot U}^{( r + 1 ) \cdot U - 1} {xDist}_{m} [ r ] ,$$

where U describes the size of the time segment covered by the spectral distance variable. The unit of U is in such embodiments defined with respect to the “tile”. In other words the unit of U is defined as the length of successive tiles which are combined. Furthermore the value of s=1, 2, 3, . . . is associated with every u=U, 2U, 3U . . . . In some embodiments the value of U can be set to infinity, where all tiles within the signal are always combined. Furthermore in such embodiments the size of the time segment can be defined to be less than the duration of the signal. For example, in some embodiments the size of the time segment can be set to a value of 30 seconds. In other words for every 30 seconds interval a new set of distance levels are determined or rendered. This short term rendering in some embodiments can be useful where the downmix signal is changing as a function of time rather than being static.

The distance accumulator can in some embodiments, output the accumulated distances to a distance mapper 505.

The operation of accumulating the spectral distances per group of tiles is shown in FIG. 8 by step 557.

In some embodiments the audio source classifier 302 further can comprise a distance mapper 505. The distance mapper 505 can be configured to map the distance values into distance levels according to a determined form. In other words the distance mapper applies a quantization operation to the distance levels to restrict the distance levels to a determined number of levels. For example in some embodiments the distance mapper 505 can carry out the following pseudo code operations to carry out the mapping. In some embodiments therefore the means for classifying can comprise means for mapping the at least one audio characteristic value associated with each audio signal to one of a defined number of audio characteristic levels.

| | |
|---|---|
| 1 | rLevel = rLevels |
| 2 | minVal = minimum value of dVal_{0,...,M-1} |
| 3 | maxVal = maximum value of dVal_{0,...,M-1} |
| 4 | incVal = (maxVal − minVal) / rLevel |
| 5 | rankIdx[1,...,N] = 0; |

6

| | |
|---|---|
| 7 | rThr = minVal; |
| 8 | While rLevel > 0 |
| 9 | { |

| | |
|---|---|
| 10 | For i = 0 to N − 1 |

| | |
|---|---|
| 11 | If dValᵢ <= rThr and dValᵢ unequal to HUGE_VALUE |
| 12 | { |

| | |
|---|---|
| 13 | rankIdx[i] = rLevel |
| 14 | dValᵢ = HUGE_VALUE |

| | |
|---|---|
| 15 | } |

16

| | |
|---|---|
| 17 | rThr += incVal; |
| 18 | rLevel −= 1; |

| | |
|---|---|
| 19 | } |

In such embodiments as shown in the pseudo code the value rLevel defines the number of distance levels to be defined. The minimum and maximum values of the distance value (dVal) are determined in lines 2 and 3 respectively. In line 4 of the pseudo code the distance value difference between the distance levels is determined, in other words the granularity of the quantization determined by the range of distance values divided by the number of determined levels to be populated. In the above pseudo code lines 7 to 19 determine the mapping of the each of the distance values into a distance levels. In such embodiments the highest distance level, in other words the level that describes best the overall audio scene is mapped to the level rLevels and the further the distance value deviates from this the lower the corresponding distance level will be.

In other words lines 7 to 19 determine which input signals are mapped to which level of the value rLevel. The condition is set in these embodiments, as shown in line 13 of the pseudo code, that if the distance value is equal to or below the distance threshold rThr and the distance value has not been processed (if the value of dVal is not a huge value) the corresponding input signal is mapped to the level rLevel. Furthermore the distance mapper 505 is then in some embodiments configured to assign the distance value to be processed. The distance mapper 505 can then, as shown in line 17 of the pseudo code increase the level threshold and as shown in line 18 decrease the distance level to indicate that the next distance level is to be processed. The distance level for each signal is then shown by the index (rankIdx).

In some embodiments the number of distance levels can be set to 7. However it would be understood that the number of levels could be greater or fewer than 7 in some embodiments. Thus in some embodiments there are means for determining a spectral distance associated with each of the set of audio signals compared to the associated reference signal.

The output mapped distances can then be output in some embodiments to an orientation mapper 303.

The mapping of distances per set of sources is shown in FIG. 8 by step 559.

In some embodiments the spectral distance determiner 503 can be configured to determine a distance based on frequency response of the signal. In other words there can comprise in some embodiments means for determining a frequency response distance with each of the set of audio signals compared to the associated reference signal. In such embodiments the first two steps of the three step process carried out by the spectral distance determiner 503 can be in some embodiments summarised by the following equations:

1. Calculate reference signal for the tile segment

$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2}$$

2. Calculate difference signal on a frequency band basis

$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert$$

Furthermore in some embodiments a hybrid distance value can be determined by the spectral distance determiner 503 whereby the distance is determined based on both the frequency response of the signal and spectral distance. In such embodiments the two determinations can be determined separately and mappings related to each determination carried out separately. In other words there can comprise in some embodiments means for mapping a first audio characteristic value associated with each audio signal to one of a first defined number of levels associated with the first classification; means for mapping a second audio characteristic value associated with each audio signal to one of a second number of levels associated with the second classification; and means for combining the first classification mapping level and the second classification mapping level.

In such embodiments the distance level for the determination is carried out as described and the mapping for the distance mapper 505 can be configured to generate a frequency response mapping carried out by a slightly different mapping operation such as described by the following pseudo code operations:

| | |
|---|---|
| 1 | rLevel = rLevels |
| 2 | minVal = minimum value of dVal_{0,...,M-1} |
| 3 | maxVal = maximum value of dVal_{0,...,M-1} |
| 4 | incVal = (maxVal − minVal) / rLevel |
| 5 | nIdx[1,...,N] = 1 |

6

| | |
|---|---|
| 7 | rThr = minVal; |
| 8 | While rLevel > 0 |
| 9 | { |

| | |
|---|---|
| 10 | For i = 0 to N − 1 |

| | |
|---|---|
| 12 | If dValᵢ <= rThr and dValᵢ unequal to HUGE_VALUE |
| 13 | { |

| | |
|---|---|
| 14 | rankIdx[i] += rLevel |
| 15 | nIdx[i] += 1 |
| 16 | dValᵢ = HUGE_VALUE |

| | |
|---|---|
| 17 | } |

18

| | |
|---|---|
| 19 | rThr += incVal; |
| 20 | rLevel −= 1; |

| | |
|---|---|
| 21 | } |
| 22 | rankIdx = rankIdx / nIdx |

In some further embodiments of the application the audio sources within an audio scene can be split into sub-groups. For example where the audio source signals received in each audio scene appear to differ greatly from each other the splitting of the audio scene into sub-groups or clusters. The exact implementation for this clustering or sub-grouping is not described further but any suitable clustering or sub-grouping operation can be used.

The classification of the audio sources is shown in FIG. 6 by step 353.

In some embodiments the classifier and transformer 201 can further comprise an orientation mapper 303 configured to receive the classified audio source information and further transform or assign the classified audio sources based on their ‘orientation’ information. In some embodiments the orientation mapper 303 can be configured to determine the orientation mapping as a two step process. The orientation mapper 303 can therefore in some embodiments convert the orientation information associated with each audio source into angle information in a unit circle. Furthermore the orientation mapper 303 in some embodiments can having converted the angle information into a unit circle organise the recording sources in each classified level according to the angle information on the unit circle. In some embodiments therefore there can comprise means for classifying the each of the set of audio signals dependent on an orientation of the audio signal.

For example if the audio source has a “north” facing recording the orientation mapper 303 can convert this information into an angle (for example 90° on the unit circle). In some embodiments the conversion from compass information to angle information can any suitable mapping, for example north represents 270°, east 180°, south 90°, and west 0°. However in some other embodiments no conversion is performed.

Thus for example where the audio sources A to F are processed with a compass direction the following orientation mappings can be carried out by the orientation mapper

| Recording sources | A | B | C | D | E | F |
|---|---|---|---|---|---|---|
| Recording | east | west | south | north | south- | north- |
| orientation | | | | | west | east |
| Recording | 180° | 0° | 90° | 270° | 45° | 225° |
| angle | | | | | | |

The mapping of audio signals is shown in FIG. 6 by step 355.

The orientation mapper 303 can further output the orientation mapped audio source information to a downmixer selector 304.

The operation of orientation mapping can be shown in FIG. 6 by step 355.

In some embodiments the classifier and transformer 201 can further comprise a downmix selector 304 which is configured to select a desired set of recording sources to be passed to the downmixer 205. The downmix selector 304 can be configured to select from the orientated and classified audio sources in order to produce an audio signal desired by the user. The downmix selector 304 can in some embodiments be configured to select at least one audio source dependent on the classification of the audio source and/or the orientation of the audio source.

In other words in some embodiments there can comprise means for selecting from the set of audio signals at least one audio signal dependent on the audio characteristic. Furthermore in some embodiments the means for selecting dependent on the audio characteristic can comprise means for selecting from the set of audio signals at least one audio signal dependent on the characteristic value mapping level.

The selection of at least one audio source for downmixing is shown in FIG. 6 by step 357.

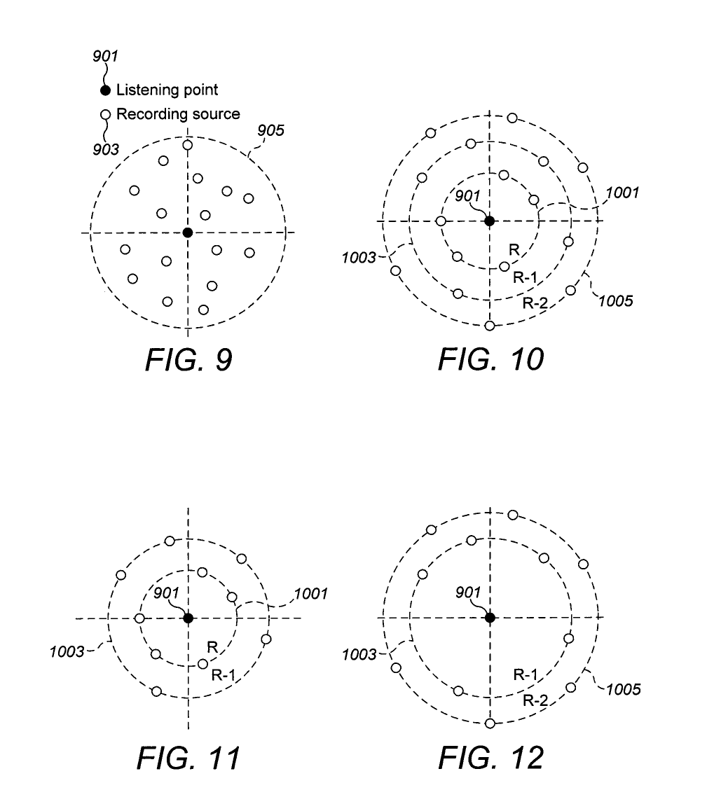

With respect to FIG. 9 an example configuration of audio sources located at positions within a defined audio scene is shown. The audio scene 905 is defined as having a circular radius (within which in embodiments of the application the recording source selector 301 selects audio sources to be classified and orientated) comprises a desired listening point 901 at the audio scene centre and a plurality of audio or recording sources 903 within the defined radius. The audio sources 903 are pictured at their estimated locations. It would be appreciated that any downmix selector attempting to select audio sources to generate a suitable downmix audio signal would find such a selection a resource and processing complex problem.

With respect to FIG. 10 the same example audio scene as shown in FIG. 9 is shown having been processed according to embodiments of the application whereby the audio sources 903 are located with regards to an orientation (generated from the orientation mapper 303) and also with regards to a classification level (generated from the audio source classifier 302). In the example shown there are three classification levels in FIG. 10, a first classification level R 1001, a second classification level R-1 1003 and a third classification level R-2 1005. These levels thus in some embodiments describe the perceptual relevance of the corresponding audio source with respect to the overall audio scene.

From this it can be seen that in some embodiments the downmix selector 304 can be configured to select audio sources according to any suitable method to achieve a suitable signal, as can be shown for example with respect to FIGS. 11 and 12.

FIG. 11 illustrates a downmix selector operation whereby the downmix selector 304 is configured to select the audio sources which are most representative of the audio scene composition (in other words as perceived by the majority of recording devices recording the audio scene). In such an example the downmix selector is configured to select audio sources which occupy the inner classification levels (the example shown in FIG. 10 shows the downmix selector configured to select the two inner most levels of the three classified levels). These can then be downmixed and transmitted to the end user.

Furthermore with respect to FIG. 12 the operation of the downmix selector 304 is shown where the selected audio sources 903 are selected because they have been classified as recording or capturing audio signals which are not representative of the audio scene. Thus in this example the downmix selector 304 is configured to select the audio sources classified as occupying the outer most levels (the example shown in FIG. 11 shows the downmix selector 304 configured to select the two outer most levels of the three classified levels). In such situations the selection can for example be used to attempt to remove a interfering source from the audio signals within the audio scene.

Although in the examples shown in FIGS. 10, 11 and 12 three levels of classified and transformed audio sources are shown, there may be greater or fewer than three levels in some embodiments of the application.

Thus in at least one of the embodiments there can be an apparatus comprising: means for selecting a set of audio signals from received audio signals; means for classifying each of the set of audio signals dependent on at least one audio characteristic; and means for selecting from the set of audio signals at least one audio signal dependent on the audio characteristic.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-81. (canceled)

82. Apparatus comprising at least one processor and at least one memory including computer code, the at least one memory and the computer code configured to with the at least one processor cause the apparatus to at least:
select a set of audio signals from received audio signals;
determine at least one audio characteristic value associated with each of the set of the audio signals compared to an associated reference signal;
classify each of the set of audio signals dependent on the at least one audio characteristic value associated with each audio signal;
determine for each received audio signal a location estimation; and
select the set of audio signals from the received audio signals dependent on the location estimation associated with the received audio signal.

83. The apparatus as claimed in claim 82, wherein select the set of audio signals from the received audio signals dependent on the location estimation associated with the received audio signal causes the apparatus to:
select the set of audio signals from the received audio signals dependent on the location estimation being within a determined audio scene area.

84. The apparatus as claimed in claim 82, wherein classify each of the set of audio signals dependent on the at least one audio characteristic value associated with each audio signal causes the apparatus to map the at least one audio characteristic value associated with each audio signal to one of a defined number of audio characteristic levels.

85. The apparatus as claimed in claim 84, wherein map the at least one audio characteristic value associated with each audio signal to one of the defined number of audio characteristic levels causes the apparatus to:
map a first audio characteristic value associated with each audio signal to one of a first defined number of levels associated with the first classification;
map a second audio characteristic value associated with each audio signal to one of a second number of levels associated with the second classification; and
combine the first classification mapping level and the second classification mapping level.

86. The apparatus as claimed in claim 85, wherein combine the first characteristic value mapping level and the second characteristic value mapping level causes the apparatus to average the first characteristic value mapping level and the second characteristic value mapping level.

87. The apparatus as claimed in claim 82, wherein determine at least one audio characteristic value associated with each of the set of the audio signals compared to a reference signal causes the apparatus to at least one of:
determine a spectral distance associated with each of the set of audio signals compared to the associated reference signal; and
determine a frequency response distance with each of the set of audio signals compared to the associated reference signal.

88. The apparatus as claimed in claim 87, wherein determine a spectral distance associated with each of the set of audio signals compared to the associated reference signal causes the apparatus to determine the spectral distance, Xdist, for each audio signal, xₘ, according to the following equations:
$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = ‖ {X}_{{diff}_{m}} [ binIdx , r ] {‖}^{2} , \\ sbOffset [ sb ] \leq binIdx < sbOffset [ sb + 1 ] ,$$
where sbOffset describes frequency band boundaries,
$${X}_{ref} [ k , r ] = \frac{{\sum }_{tl = l \cdot L}^{( l + 1 ) \cdot L - 1} {\sum }_{m = 90}^{N - 1} {X}_{{tile}_{m}} [ k . tl ]}{N} , \\ {X}_{{tile}_{m}} [ k , r ] = {X}_{m} [ k , tl ] , \\ l \cdot L \leq tl < ( l + 1 ) \cdot L , \\ where r = 1 , 2 , 3 , … for every t 1 = L , 2 L , 3 L , \\ {X}_{m} [ k , l ] = TF ( {x}_{m , l , T} ) ,$$
where m is the signal index, k is a frequency bin index, l is a time frame index, T is a hop size between successive segments and TF is a time to frequency operator.

89. The apparatus as claimed in claim 87, wherein determine a frequency response distance with each of the set of audio signals compared to the associated reference signal causes the apparatus to determine the difference signal, Xdist, for each audio signal, xₘ, according to the following equations:
$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$
where sbOffset describes frequency band boundaries,
$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , \\ l \cdot L \leq tl < ( l + 1 ) \cdot L ,$$
where r=1, 2, 3, . . . for every tl=L, 2L, 3L, Xᵢₙ[k,l]=TF(x_{m,l,T}), where m is the signal index, k is a frequency bin index, l is a time frame index, T is a hop size between successive segments and TF is a time to frequency operator.

90. The apparatus as claimed in claim 82, wherein classify each of the set of audio signals dependent on the at least one classification value associated with each audio signal causes the apparatus to:
further classify the each of the set of audio signals dependent on an orientation of the audio signal, and wherein select from the set of audio signals at least one audio signal dependent on the audio characteristic causes the apparatus to select from the set of audio signals at least one audio signal dependent on the characteristic value mapping level

91. The apparatus as claimed in claim 82, further caused to receive at least one audio scene parameter, wherein the audio scene parameter comprises at least one of:
an audio scene location;
an audio scene area;
an audio scene radius;
an audio scene direction; and
an audio scene perceptual relevance.

92. A method comprising:
selecting a set of audio signals from received audio signals;
determining at least one audio characteristic value associated with each of the set of the audio signals compared to an associated reference signal;
classifying each of the set of audio signals dependent on the at least one audio characteristic value associated with each audio signal;
determining for each received audio signal a location estimation; and
selecting the set of audio signals from the received audio signals dependent on the location estimation associated with the received audio signal.

93. The method as claimed in claim 92, wherein selecting the set of audio signals from the received audio signals dependent on the location estimation associated with the received audio signal comprises:
selecting the set of audio signals from the received audio signals dependent on the location estimation being within a determined audio scene area.

94. The method as claimed in claim 92, wherein classifying each of the set of audio signals dependent on the at least one audio characteristic value associated with each audio signal comprises mapping the at least one audio characteristic value associated with each audio signal to one of a defined number of audio characteristic levels.

95. The method as claimed in claim 94, wherein mapping the at least one audio characteristic value associated with each audio signal to one of the defined number of audio characteristic levels comprises:
mapping a first audio characteristic value associated with each audio signal to one of a first defined number of levels associated with the first classification;
mapping a second audio characteristic value associated with each audio signal to one of a second number of levels associated with the second classification; and
combining the first classification mapping level and the second classification mapping level.

96. The method as claimed in claim 95, wherein combining the first characteristic value mapping level and the second characteristic value mapping level comprises averaging the first characteristic value mapping level and the second characteristic value mapping level.

97. The method as claimed in claim 82, wherein determining at least one audio characteristic value associated with each of the set of the audio signals compared to a reference signal comprises at least one of:
determining a spectral distance associated with each of the set of audio signals compared to the associated reference signal; and
determining a frequency response distance with each of the set of audio signals compared to the associated reference signal.

98. The method as claimed in claim 97, wherein determining a spectral distance associated with each of the set of audio signals compared to the associated reference signal comprises determining the spectral distance, Xdist, for each audio signal, xₘ, according to the following equations:
$${X}_{{diff}_{m}} [ k , r ] = {\sum }_{tl = l \cdot L}^{( l + 1 ) \cdot L - 1} ( {X}_{ref} [ k , r ] - {X}_{{tile}_{m}} [ k , tl ] ) , \\ {Xdist}_{m} [ sb , r ] = {‖ {X}_{{diff}_{m}} [ binIdx , r ] ‖}^{2} , \\ sbOffset [ sb ] \leq binIdx < sbOffset [ sb + 1 ] ,$$
where sbOffset describes frequency band boundaries,
$${X}_{ref} [ k , r ] = \frac{{\sum }_{tl = l \cdot L}^{( l + 1 ) \cdot L - 1} {\sum }_{m = 0}^{N - 1} {X}_{{tile}_{m}} [ k . tl ]}{N} , \\ {X}_{{tile}_{m}} [ k , r ] = {X}_{m} [ k , tl ] , \\ l \cdot L \leq tl < ( l + 1 ) \cdot L ,$$
where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

99. The method as claimed in claim 97, wherein determining a frequency response distance with each of the set of audio signals compared to the associated reference signal comprises determining the difference signal, Xdist, for each audio signal, xₘ, according to the following equations:
$${X}_{{diff}_{m}} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {X}_{{tile}_{m}} [ binIdx , tl ] ‖}^{2} , \\ {Xdist}_{m} [ sb , r ] = \vert {X}_{ref} [ sb , r ] - {X}_{{diff}_{m}} [ sb , r ] \vert ,$$
where sbOffset describes frequency band boundaries,
$${X}_{ref} [ sb , r ] = {‖ {\sum }_{binIdx = sbOffset [ sb ]}^{sbOffset [ sb + 1 ] - 1} {\sum }_{tl = l \cdot L}^{( l + 1 ) \cdot L - 1} {\sum }_{m = 0}^{N - 1} {X}_{{tile}_{m}} [ binIdx , tl ] ‖}^{2} , \\ {X}_{{tile}_{m}} [ k , r ] = {X}_{m} [ k , tl ] , \\ l \cdot L \leq tl < ( l + 1 ) \cdot L ,$$
where r=1, 2, 3, . . . for every tl=L, 2L, 3L, Xₘ[k,l]=TF(x_{m,l,T}), where m is the signal index, k is a frequency bin index, l is a time frame index, T is a hop size between successive segments and TF is a time to frequency operator.

100. The method as claimed in claim 92, wherein classifying each of the set of audio signals dependent on the at least one classification value associated with each audio signal comprises:
further classifying the each of the set of audio signals dependent on an orientation of the audio signal, wherein selecting from the set of audio signals at least one audio signal dependent on the audio characteristic comprises selecting from the set of audio signals at least one audio signal dependent on the characteristic value mapping level

101. The method as claimed in claim 92, further comprising receiving at least one audio scene parameter, wherein the audio scene parameter comprises at least one of:
an audio scene location;
an audio scene area;
an audio scene radius;
an audio scene direction; and
an audio scene perceptual relevance.
